(19) United States
(12) Patent Application Publication
(10) Pub. No.: US 2006/0185422 A1
(43) Pub. Date: Aug. 24, 2006

(54) Knock determination device for internal combustion engine

(76) Inventors: Kiyoshi Iwade, Okazaki-shi (JP); Shuhei Oe, Kariya-shi (JP); Nobuyuki Murate, Okazaki-shi (JP); Rihito Kaneko, Nishikamo-gun (JP); Yuichi Takemura, Anjo-shi (JP)

Correspondence Address: KENYON & KENYON LLP, 1500 K STREET N.W., SUITE 700, WASHINGTON, DC, 20005, US

(21) Appl. No.: 11/348,332

(22) Filed: Feb. 7, 2006

(30) Foreign Application Priority Data
Feb. 21, 2005 (JP) 2005-044482 (P)

(51) Int. Cl. G01L 23/22

(52) U.S. Cl. 73/35.09

(57) ABSTRACT

An engine ECU includes: an A/D (Analog/Digital) converter converting an analog signal transmitted from a knock sensor provided at a cylinder block into a digital signal; a bandpass filter passing only a vibration of a third order tangential resonance mode frequency band; and a bandpass filter passing only a vibration of a fourth order tangential resonance mode frequency band. The engine ECU determines whether the engine knocks, as based on the vibration selected by means of the bandpass filter or bandpass filter.

This nonprovisional application is based on Japanese Patent Application No. 2005-044482 filed with the Japan Patent Office on Feb. 21, 2005, the entire contents of which are hereby incorporated by reference.

### BACKGROUND OF THE INVENTION

1. Field of the Invention

The present invention relates to a knock determination device and particularly to a knock determination device for an internal combustion engine that determines based on a vibration of a specific frequency band of the internal combustion engine whether the engine knocks.

2. Description of the Background Art

Conventionally, a technique for determining whether an internal combustion engine knocks based on a vibration of a frequency band that is specific to knocking among vibrations of the internal combustion engine is known.

Japanese Patent Laying-Open No. 01-178773 discloses a knocking detection method for a gasoline engine including the steps of extracting knocking information related to a high frequency band of at least 10 kHz, comparing a vibration amplitude of the high-frequency knock information with a threshold value, and further comparing the comparison result with a comparison result obtained from the previous ignition to detect the difference.

According to the knocking detection method for a gasoline engine disclosed, in an output waveform of a BPF (Band Pass Filter) of 10 kHz, even a substantially intense knocking occurs only at a probability of about once in several to several tens of strokes, and it does not occur successively in the same cylinder. On the other hand, a mechanical noise such as a valve seating noise is cyclic, of which increase/decrease is not abrupt, and the noise occurs successively in the same cylinder. Accordingly, it is possible to distinguish knock from other mechanical noises, as based on successiveness. Thus, whether a noise is knock can be determined, by passing a high frequency through a BPF, and then detecting a vibration that is great to a certain degree to be compared with a vibration detected at the previous stroke.

Japanese Patent Laying-Open No. 55-144521 discloses a knocking detecting device for an internal combustion engine including: a plurality of detectors having different resonance characteristics; a vibration detector detecting each of knocking vibrations of different frequency bands of the internal combustion engine; an engine state determiner determining whether any of an engine speed, a vibration noise from the vibration detector and an engine load is at least or at most a prescribed value; a selector selecting a low frequency band side from each vibration output of the vibration detector when any of the engine speed, vibration noise and engine load is at most a prescribed value and selecting a high-frequency band side when any of the engine speed, vibration noise and engine load are at least the prescribed value, in accordance with an engine state determined by the engine state determiner; and a determiner determining whether the engine knocks based on a comparison with a vibration noise level created in accordance with the vibration output. The high frequency band side is set to 11 kHz-13 kHz, while the low frequency band side is set to 7 kHz-10 kHz.

According to the knocking detecting device for an internal combustion engine disclosed, each of knocking vibrations of different frequency bands of an internal combustion engine is detected. The vibration outputs are switched to detect knocking. Thus, addressing critical problems such as deteriorated fuel economy and efficiency, which would be invited when detection of knocking with high precision fails because of increased vibration noises from the engine driving at high speed or bearing high load, or the melting of a vibration plug as a result of control, an output of low frequency band with relatively good sensitivity can be used in an engine operation state with less noise, while an output of high frequency band having excellent S/N ratio can be used in high-speed, high-load state. Accordingly, over the entire operation range of the engine, weak trace knocking can be detected with constant precision, and fuel economy and efficiency of the engine largely improve.

According to the knocking detection method for a gasoline engine disclosed in Japanese Patent Laying-Open No. 01-178773, knocking is detected based on a vibration of a frequency band of at least 10 kHz. According to the knocking detecting device disclosed in Japanese Patent Laying-Open No. 55-144521, knocking is detected based on a vibration of a frequency band of 11 kHz-13 kHz or of a frequency band of 7 kHz-10 kHz. However, through a further frequency analysis, the present applicant found a frequency band that is superior to those frequency bands in detecting knocking. Those frequency bands of at least 10 kHz and of 11 kHz-13 kHz or 7 kHz-10 kHz are not identical to the frequency band found by the present applicant, and they still require an improvement in determining whether the engine knocks with high precision.

### SUMMARY OF THE INVENTION

An object of the present invention is to provide a knocking determination device for an internal combustion engine that can determine whether the engine knocks with high precision.

A knock determination device for an internal combustion engine according to one aspect of the present invention includes: a vibration detector detecting a vibration of the internal combustion engine; an extractor extracting from the detected vibration a vibration of at least one of a third order tangential resonance mode frequency band and a fourth order tangential resonance mode frequency band in a cylinder of the internal combustion engine; and a determiner determining whether the internal combustion engine knocks, as based on the extracted vibration.

According to the present invention, an in-cylinder pressure of the internal combustion engine resonates due to knocking. Due to the resonance of the in-cylinder pressure, the internal combustion engine vibrates. Specifically, by extracting vibrations included in an in-cylinder pressure resonance frequency band from the vibrations of the internal combustion engine, vibrations specific to knocking can be extracted. The in-cylinder pressure resonance frequency corresponds to a resonance mode of an in-cylinder air column vibration. The resonance modes which can specifically be detected when the engine knocks representatively include the first, second, third, and fourth order tangential resonance modes. Resonance frequencies of the cylinder block, piston, connecting rod, crank shaft and the like of the internal combustion engine are present near the first and second order tangential resonance mode frequency bands among those resonance mode frequency bands. Therefore, vibrations of the first and second order tangential frequency bands among the vibrations of the internal combustion engine are affected by the resonance frequencies of the cylinder block, piston, connecting rod, crank shaft and the like of the internal combustion engine. Accordingly, the characteristics of the vibrations of the first and second order tangential frequency bands among the vibrations of the internal combustion engine are not identical to the characteristics of in-cylinder pressure in the first and second order tangential resonance modes. Specifically, the vibrations of the first and second order tangential frequency bands include noises other than knocking. On the other hand, the characteristics of the vibrations of the third and fourth order tangential frequency bands among the vibrations of the internal combustion engine are identical to the characteristics of in-cylinder pressure in the third and fourth order tangential resonance modes. Therefore, from the vibrations of the internal combustion engine, a vibration of at least one of the third and fourth order tangential resonance mode frequency bands is extracted. Thus, a vibration with less noise other than knocking can be extracted. Thus, a vibration that is specific to knocking can be extracted with high precision. Based on the vibration, whether the engine knocks is determined. As a result, a knocking determination device for an internal combustion engine that can determine whether the engine knocks with high precision can be provided.

A knock determination device for an internal combustion engine according to another aspect of the present invention includes: a vibration detector detecting a vibration of the internal combustion engine; an extractor extracting from the detected vibration a vibration of at least 14 kHz; and a determiner determining whether the internal combustion engine knocks, as based on the extracted vibration.

According to the present invention, an in-cylinder pressure of the internal combustion engine resonates due to knocking. Due to the resonance of the in-cylinder pressure, the internal combustion engine vibrates. Specifically, by extracting vibrations included in an in-cylinder pressure resonance frequency band from the vibrations of the internal combustion engine, vibrations specific to knocking can be extracted. The in-cylinder pressure resonance frequency corresponds to a resonance mode of an in-cylinder air column vibration. The resonance modes which can specifically be detected when the engine knocks representatively include the first, second, third, and fourth order tangential resonance modes. Resonance frequencies of the cylinder block, piston, connecting rod, crank shaft and the like of the internal combustion engine are present near the first and second order tangential resonance mode frequency bands among those resonance mode frequency bands. Therefore, vibrations of the first and second order tangential frequency bands among the vibrations of the internal combustion engine are affected by the resonance frequencies of the cylinder block, piston, connecting rod, crank shaft and the like of the internal combustion engine. Accordingly, the characteristics of the vibrations of the first and second order tangential frequency bands among the vibrations of the internal combustion engine are not identical to the characteristics of in-cylinder pressure in the first and second order tangential resonance modes. Specifically, the vibrations of the first and second order tangential frequency bands include noises other than knocking. On the other hand, the characteristics of the vibrations of the third and fourth order tangential frequency bands among the vibrations of the internal combustion engine are identical to the characteristics of in-cylinder pressure in the third and fourth order tangential resonance modes. Herein, the first and second order tangential frequency bands are less than 14 kHz, and the third and fourth order tangential frequency bands are at least 14 kHz. Accordingly, a vibration of at least 14 kHz is extracted from the vibrations of the internal combustion engine. Thus, a vibration with less noise other than knocking can be extracted. Thus, a vibration that is specific to knocking can be extracted with high precision. Based on the vibration, whether the engine knocks is determined. As a result, a knocking determination device for an internal combustion engine that can determine whether the engine knocks with high precision can be provided.

Preferably, the knock determination device further includes: a waveform detector detecting a waveform of a vibration at predetermined crank angle intervals as based on the extracted vibration; and a storage storing in advance a waveform of a vibration of the internal combustion engine. The determiner determines whether the internal combustion engine knocks, as based on a result of comparing the detected waveform with the stored waveform.

According to the present invention, an experiment or the like is conducted to create a knock waveform model that is a waveform of a vibration when the engine knocks and to store the same in advance. Based on the comparison between the knock waveform model and a detected waveform, whether the engine knocks is determined. Thus, in addition to the magnitude of a vibration, the timing at which the vibration occurs can be depended on to determine whether the engine knocks. As a result, whether the engine knocks can be determined with high precision.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic configuration diagram showing an engine controlled by a knock determination device according to an embodiment of the present invention.

FIG. 2 is a control block diagram (1) showing an engine ECU in FIG. 1

FIG. 3 is a diagram (1) showing a frequency band of a vibration of in-cylinder pressure.

FIG. 4 is a diagram (2) showing a frequency band of a vibration of in-cylinder pressure.

FIG. 5 is a diagram showing a frequency band of a vibration detected by a knock sensor.

FIG. 6 is a diagram showing a resonance frequency of a cylinder block, a piston, a connecting rod, a crank shaft and the like.

FIG. 7 is a diagram showing a knock waveform model stored in the memory of the engine ECU.

FIG. 8 is a flowchart showing a control structure of a program executed by the engine ECU in FIG. 1.

FIG. 9 is a diagram showing a vibration waveform of the engine.

FIG. 10 is a diagram showing comparison between a normalized vibration waveform and the knock waveform model.

FIG. 11 is a control block diagram (2) showing the engine ECU in FIG. 1.

### DESCRIPTION OF THE PREFERRED EMBODIMENTS

Hereinafter with reference to the drawings the present invention in embodiments will be described. In the following description, identical components are identically denoted. They are also identical in name and function. Therefore, detailed description thereof will not be repeated.

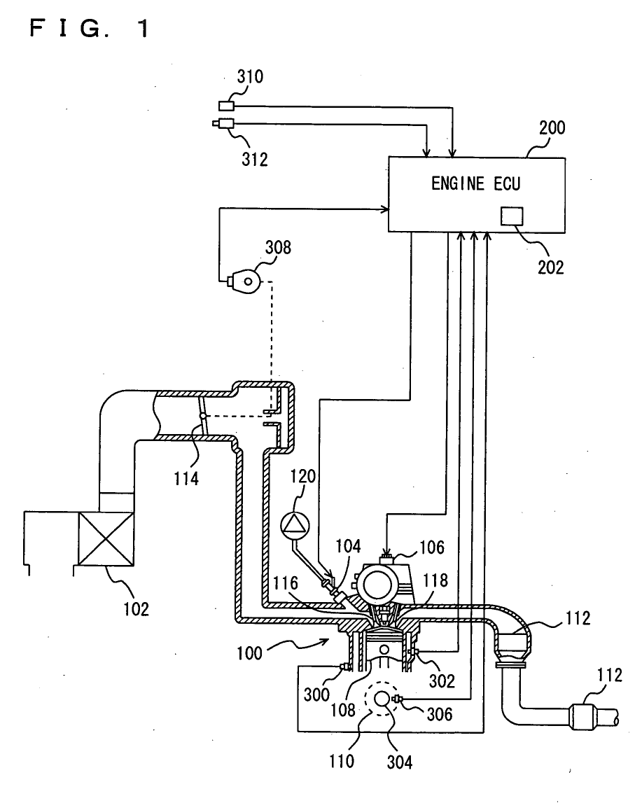

With reference to FIG. 1, an engine 100 of a vehicle incorporating a knock determination device according to an embodiment of the present invention will be described. The knock determination device according to the present embodiment is implemented by a program executed by an engine ECU (Electronic Control Unit) 200, for example.

Engine 100 is an internal combustion engine that allows a mixture of air aspirated through an air cleaner 102 and a fuel injected by an injector 104 to be ignited in a combustion chamber by a spark plug 106 and thus combusted.

The air-fuel mixture combusted causes combustion pressure which presses a piston 108 down and a crank shaft 110 rotates. The combusted air-fuel mixture (or exhaust gas) is purified by a three-way catalyst 112 and thereafter discharged outside the vehicle. Engine 100 aspirates an amount of air adjusted by a throttle valve 114.

Engine 100 is controlled by engine ECU 200 having connected thereto a knock sensor 300, a water temperature sensor 302, a crank position sensor 306 arranged opposite a timing rotor 304, a throttle opening sensor 308, a vehicle speed sensor 310, and an ignition switch 312.

Knock sensor 300 is provided to a boss portion formed in the cylinder block of engine 100. Knock sensor 300 is implemented by a piezoelectric element. As engine 100 vibrates, knock sensor 300 generates a voltage having a magnitude corresponding to that of the vibration. Knock sensor 300 transmits a signal representing the voltage to engine ECU 200. Water temperature sensor 302 detects temperature of refrigerant water in engine 100 at a water jacket and transmits a signal representing a resultant detection to engine ECU 200.

Timing rotor 304 is provided at a crank shaft 110 and rotates as crank shaft 110 does. Timing rotor 304 is circumferentially provided with a plurality of protrusions spaced as predetermined. Crank position sensor 306 is arranged opposite the protrusions of timing rotor 304. When timing rotor 304 rotates,. an air gap between the protrusions of timing rotor 304 and crank position sensor 306 varies, and a coil portion of crank position sensor 306 passes an increased/decreased magnetic flux and thus experiences electromotive force. Crank position sensor 306 transmits a signal representing the electromotive force to engine ECU 200. From the signal, engine ECU 200 detects a crank angle.

Throttle opening sensor 308 detects a throttle opening and transmits a signal representing a resultant detection to engine ECU 200. Vehicle speed sensor 310 detects a rate of rotation of a wheel (not shown) and transmits a signal representing a resultant detection to engine ECU 200. From the wheel's rate of rotation engine ECU 200 calculates the vehicle's speed. Ignition switch 312 is turned on by a driver starting engine 100.

Engine ECU 200 uses the signals transmitted from each sensor and ignition switch 312 and a map and program stored in a memory 202 to perform an arithmetic operation to control equipment so that engine 100 has a desired driving condition.

In the present embodiment engine ECU 200 depends on a signal transmitted from knock sensor 300 and a crank angle to detect a waveform of a vibration of engine 100 at a predetermined knock detection gate (a section from a predetermined first crank angle to a predetermined second crank angle) (hereinafter such waveform of a vibration will also simply be referred to as “vibration waveform”) and from the detected vibration waveform determines whether engine 100 knocks. The knock detection gate of the present embodiment is from the top dead center (0°) to 90°in a combustion process. It is noted that the knock detection gate is not limited thereto.

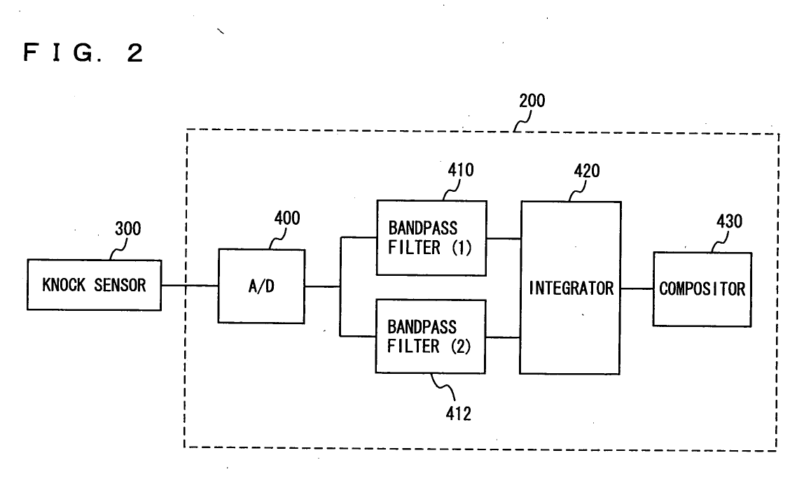

Referring to FIG. 2, engine ECU 200 is described further. Engine ECU 200 includes an A/D (Analog/Digital) converter 400, a bandpass filter (1) 410, a bandpass filter (2) 412, an integrator 420, and a compositor 430.

A/D converter 400 converts an analog signal transmitted from knock sensor 300 into a digital signal. Bandpass filter (1) 410 passes only a signal of a third order tangential resonance mode frequency band among the signals transmitted from knock sensor 300. That is, by bandpass filter (1) 410, only a vibration of the third order tangential resonance mode frequency band is extracted from the vibrations detected by knock sensor 300. Bandpass filter (2) 412 passes only a signal of a fourth order tangential resonance mode frequency band among the signals transmitted from knock sensor 300. That is, by bandpass filter (2) 412, only a vibration of the fourth order tangential resonance mode frequency band is extracted from the vibrations detected by knock sensor 300.

Integrator 420 integrates the signals selected by bandpass filter (1) 410 or bandpass filter (2) 412, that is, the vibration's magnitude, for a crank angle of every five degrees. Hereinafter, the value obtained from the integration is referred to as an integrated value. The integrated value is calculated for each frequency band. The compositor 430 sums for each corresponding crank angle the integrated values calculated for respective frequency bands. In other words, it composites the integrated values calculated for respective frequency bands. Thus, a vibration waveform of engine 100 is created.

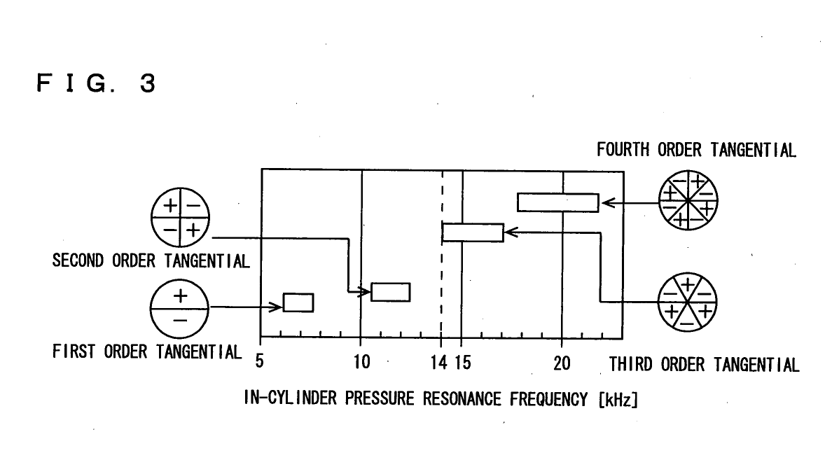

Referring to FIGS. 3-6, frequency bands of bandpass filter (1) 410 and bandpass filter (2) 412 are described. When knocking occurs inside a cylinder of engine 100, the in-cylinder pressure resonates. This resonance of in-cylinder pressure causes the cylinder block of engine 100 to vibrate. Thus, the vibration of the cylinder block, that is, the frequency of the vibration detected by knock sensor 300 is often included in an in-cylinder pressure resonance frequency band.

The in-cylinder pressure resonance frequency corresponds to the resonance mode of an in-cylinder air column. The frequency bands where a vibration specific to knocking appears representatively include the first, second, third, and fourth order tangential resonance mode frequency bands.

The in-cylinder pressure resonance frequency is calculated from resonance mode, a bore diameter and a sonic speed. FIG. 3 shows one example of the in-cylinder pressure resonance frequency for each resonance mode, under a constant sonic speed and bore diameters varying from X to Y. As shown by FIG. 3, the in-cylinder pressure resonance frequency is higher in ascending order of the first, second, third, and fourth order tangential frequency bands. The first and second order tangential frequency bands are less than 14 kHz, while the third and fourth order tangential frequency bands are at least 14 kHz.

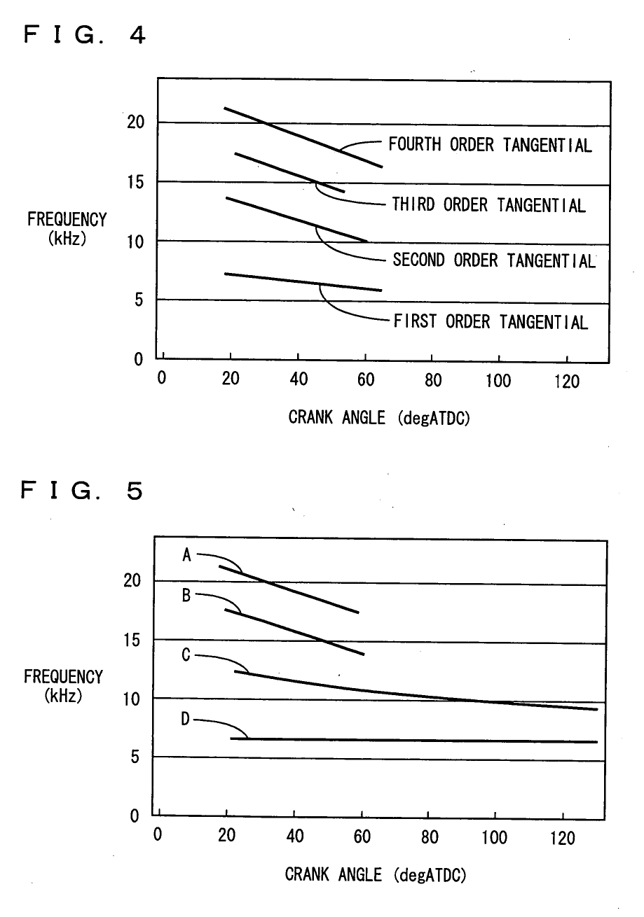

FIG. 3 shows the in-cylinder pressure resonance frequency at the timing where knocking occurs. After knocking occurs, the volume of the combustion chamber increases as the piston is lowered, and hence the temperature and the pressure inside the combustion chamber decrease. As a result, the sonic speed decreases, and the in-cylinder pressure resonance frequency decreases. Accordingly, as shown in FIG. 4, as the crank angle increases from ATDC (After Top Dead Center), the peak component of the frequency of the in-cylinder pressure decreases.

Due to the resonance of the in-cylinder pressure having such characteristics, the cylinder block vibrates. Therefore, as shown in FIG. 5, in an ignition cycle where knocking has occurred, the vibrations detected by knock sensor 300 include a vibration of frequency band A that is the same as the fourth order tangential resonance mode frequency band, and a vibration of frequency band B that is the same as the third order tangential resonance mode frequency band.

As shown by FIGS. 4 and 5, the characteristics of the vibration of frequency band A are identical to the characteristics of the vibration of the in-cylinder pressure of the fourth order tangential frequency band. The characteristics of the vibration of frequency band B match the characteristics of the vibration of the in-cylinder pressure of the third order tangential frequency band. Accordingly, among the vibrations detected by knock sensor 300, vibrations of frequency bands A and B can be recognized as being specific to knocking.

On the other hand, as shown by FIGS. 4 and 5, the characteristics of the vibration of frequency band C that is the same as the second order tangential frequency band are not identical to vibration of the in-cylinder pressure of the second order tangential frequency band. The characteristics of the vibration of frequency band D that is the same as the tangential first frequency band are not identical to vibration of the in-cylinder pressure of the first order tangential frequency band.

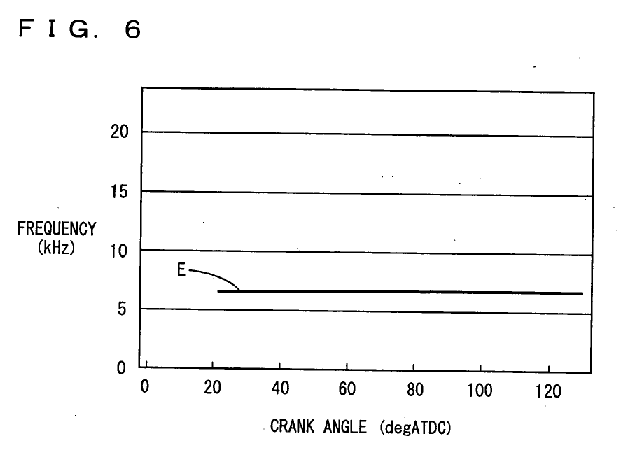

This is due to the fact that, as shown in FIG. 6, a resonance frequency E of the cylinder block, piston, connecting rod, crank shaft and the like is present near frequency bands C and D, and that vibrations of frequency bands C and D include noises other than the vibration attributed to knocking.

In the present embodiment, in order to remove noises other than the vibration attributed to knocking, only vibrations of the third and fourth order tangential frequency bands (frequency bands A and B) are extracted by means of bandpass filter (1) 410 and bandpass filter (2) 412 from vibrations detected by knock sensor 300, to create a vibration waveform of engine 100.

The obtained vibration waveform is compared with a knock waveform model stored in memory 202 of engine ECU 200. The knock waveform model is the model of a vibration waveform where engine 100 knocks.

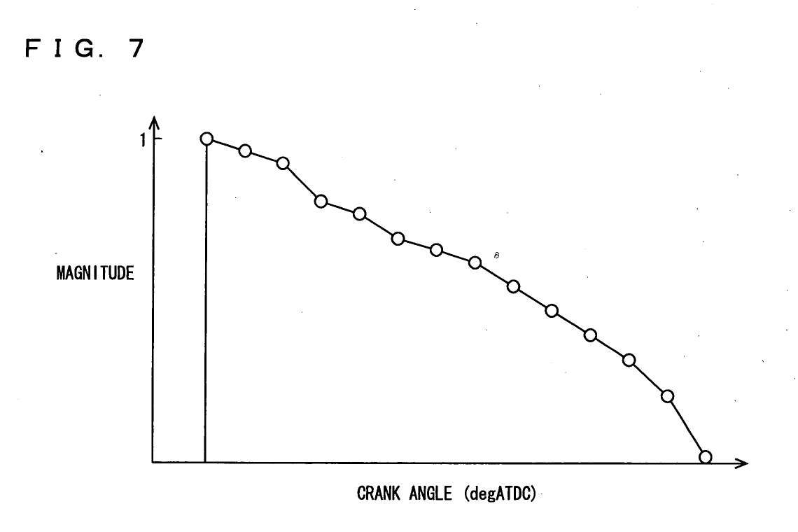

As shown in FIG. 7, in the knock waveform model, a vibration's magnitude is represented by a dimensionless number of 0 to 1 and does not uniquely correspond to a crank angle. More specifically, for the present embodiment's knock waveform model, while it is determined that the vibration decreases in magnitude as the crank angle increases after a vibration's peak value in magnitude, the crank angle at which the vibration has the peak value in magnitude is not determined. Furthermore, the knock waveform model is a wave of a composition of vibrations of the third and fourth order tangential frequency bands (frequency bands A and B).

The present embodiment's knock waveform model corresponds to the portion of a vibration caused by knocking following the peak value in magnitude of the vibration. It should be noted that a knock waveform model corresponding to a vibration attributed to knocking following the rise of the vibration may be stored.

The knock waveform model is obtained as follows: an experiment or the like is conducted to cause engine 100 to knock to detect the engine 100 vibration waveform, from which the knock waveform model is created and stored in advance. It should be noted, however, that the knock waveform model may be created by a different method. Engine ECU 200 compares a detected waveform with the stored knock waveform model to determine whether engine 100 knocks.

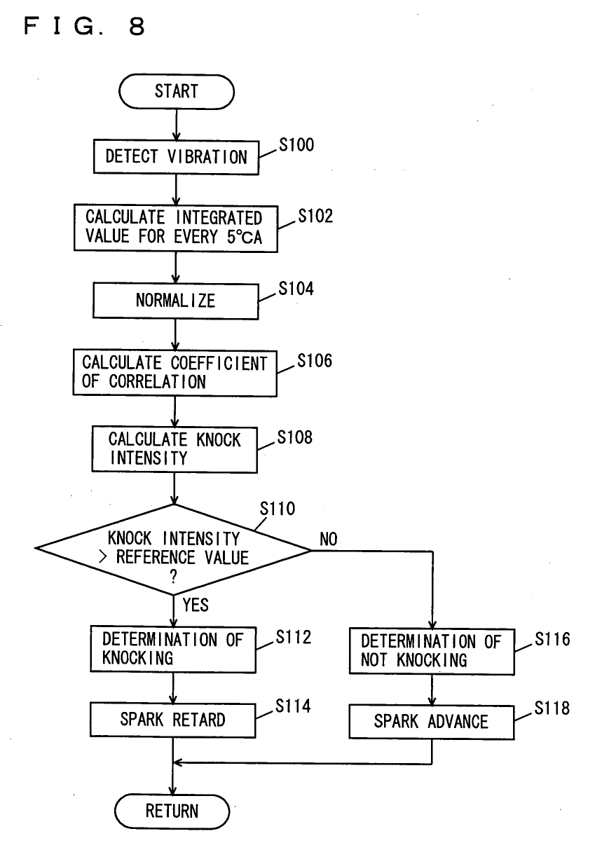

With reference to FIG. 8, a control structure of a program executed by engine ECU 200 in the present embodiment's knock determination device will be described hereinafter.

At step (hereinafter simply referred to as “S”) 100 engine ECU 200 detects the magnitude of engine 100 vibration from a signal transmitted from knock sensor 300. The vibration's magnitude is represented by a value of voltage output from knock sensor 300. Note that the vibration's magnitude may be represented by a value corresponding to the value of the voltage output from knock sensor 300. The vibration's magnitude is detected in a combustion process for an angle from a top dead center to (a crank angle of) 90°.

At S102 engine ECU 200 calculates for a crank angle of every five degrees an integration (hereinafter also be referred to as an “integrated value”) of values of voltage output from knock sensor 300 (i.e., representing magnitude of vibration). The integrated value is calculated for each frequency band. Then, the integrated values are composited together. Thus a vibration waveform of engine 100 is created.

At S104, engine ECU 200 normalizes the vibration waveform. Herein, normalizing a waveform means dividing each integrated value by the largest of the integrated values in the detected waveform, for example, so that the vibration's magnitude is represented by a dimensionless number of 0 to 1. It is noted that the value by which each integrated value is divided is not limited to the largest integrated value.

At S106 engine ECU 200 calculates a coefficient of correlation K, which is a value related to a deviation between the normalized vibration waveform and the knock waveform model. A timing of a normalized vibration waveform providing a vibration maximized in magnitude and that of a knock waveform model providing a vibration maximized in magnitude are matched, while a deviation in absolute value (or an amount of offset) between the normalized vibration waveform and the knock waveform model is calculated for each crank angle (of five degrees) to calculate the coefficient of correlation K.

If the normalized vibration waveform and the knock waveform model provide a deviation ΔS (I) (wherein I is a natural number) in absolute value for each crank angle and the knock waveform model's vibration as represented in magnitude integrated by the crank angle (i.e., the knock waveform model's area) is represented by S, then the coefficient of correlation K is calculated by an equation K=(S−ΣΔS (I))/S, wherein ΣΔS (I) represents a sum of ΔS(I)s for the top dead center to 90°. Note that the coefficient of correlation K may be calculated by a different method.

At S108 engine ECU 200 calculates a knock intensity N. If calculated integrated values have a largest value P and engine 100 does not knock and vibrates with a magnitude represented in value by a background level (BGL), then knock intensity N is calculated by an equation N=P×K/BGL. The BGL is stored in memory 202. Note that knock intensity N may be calculated by a different method.

At S110 engine ECU 200 determines whether knock intensity N is larger than a predetermined reference value. If so (YES at S110) the control proceeds with S112, otherwise (NO at S110) the control proceeds with S116.

At S112 engine ECU 200 determines that engine 100 knocks. At S114 engine ECU 200 introduces a spark retard. At S116 engine ECU 200 determines that engine 100 does not knock. At S118 engine ECU 200 introduces a spark advance.

An operation of engine ECU 200 of the knock determination device according to the present embodiment based on the above-described configuration and flowchart will be described.

When a driver turns on ignition switch 312 and engine 100 starts, the engine 100 vibration is detected in magnitude from a signal transmitted from knock sensor 300 (S100).

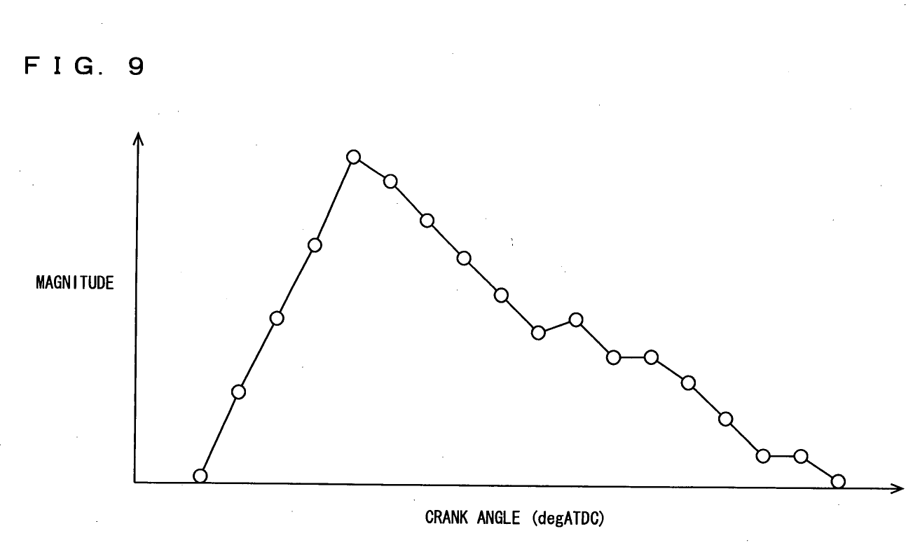

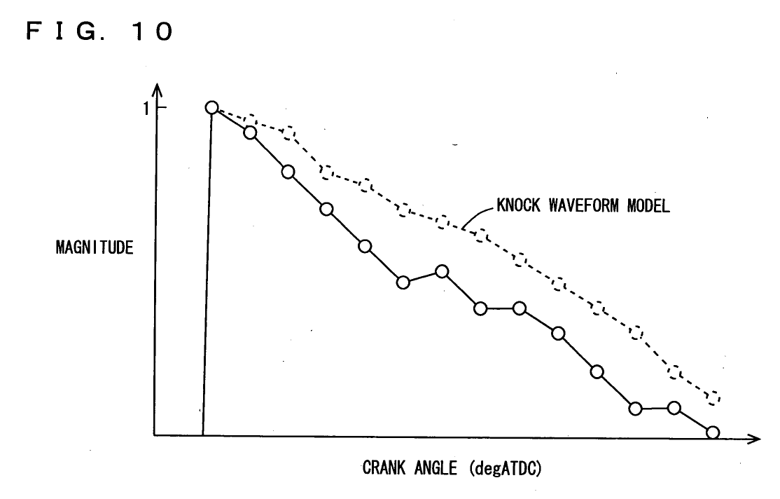

In a combustion process for a range from the top dead center to 90° an integrated value for every five degrees is calculated for respective vibrations of the third and fourth order tangential frequency bands (frequency bands A and B) (S102). Then, the calculated integrated values are composited together. Thus, as shown in FIG. 9, the engine 100 vibration waveform is detected as a wave of a composition of the vibrations of the third and fourth order tangential frequency bands.

Using an integrated value for every five degrees to detect a vibration waveform allows minimized detection of a waveform of vibration having a complicated form attributed to a vibration having a magnitude varying minutely. This can help to compare a detected vibration waveform with a knock waveform model.

In order to compare the vibration waveform with the knock waveform model, each integrated value is divided by the largest of the integrated values to normalize the vibration waveform (S104). Herein, it is assumed that each integrated value is divided by the integrated value for 20°-25° (the fifth integrated value from the left in FIG. 9) to normalize the vibration waveform. By the normalization, a vibration's magnitude in the vibration waveform is represented by a dimensionless number of 0 to 1. Thus, the detected vibration waveform can be compared with the knock waveform model regardless of the vibration's magnitude. This can eliminate the necessity of storing a large number of knock waveform models corresponding to the magnitude of vibration and thus help to create a knock waveform model.

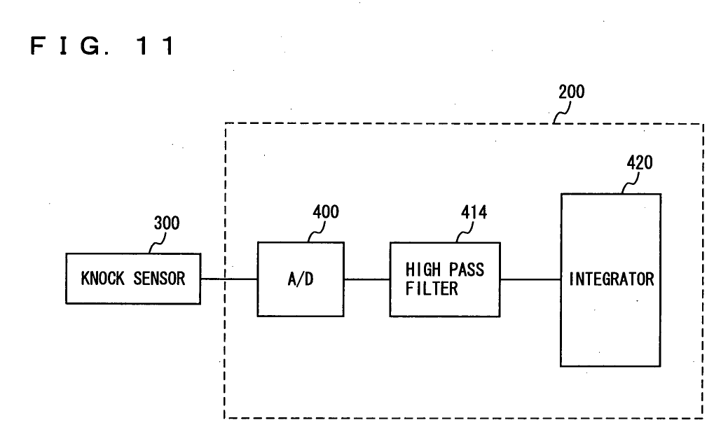

As shown in FIG. 10, a timing of a normalized vibration waveform providing a vibration maximized in magnitude and that of a knock waveform model providing a vibration maximized in magnitude are matched, while a deviation in absolute value ΔS (I) between the normalized vibration waveform and the knock waveform model is calculated for each crank angle. Sum σΔS (I) of such ΔS (I)s and value S representing a magnitude of vibration in knock waveform model that is integrated by crank angle are used to calculate the coefficient of correlation K=(S−σΔS (I))/S (S106). This allows a degree of matching of a detected vibration waveform and a knock waveform model to be numerically represented and thus objectively determined.

The product of the calculated coefficient of correlation K and the largest integrated value P is divided by the BGL to calculate knock intensity N (S108). Thus, in addition to the degree of matching between the detected vibration waveform and the knock waveform model, vibration's magnitude can also be depended on to analyze in more detail whether the engine 100 vibration is attributed to knocking. Here, it is assumed that the product of coefficient of correlation K and the integrated value for 20°-25° is divided by BGL to calculate knock intensity K.

If knock intensity N is larger than a predetermined reference value (YES at S110) a determination is made that engine knocks (S112) and a spark retard is introduced (S114) to prevent the engine from knocking.

If knock intensity N is not larger than the predetermined reference value (NO at S110), a determination is made that the engine does not knock (S116) and a spark advance is introduced (S118).

Thus, in the present embodiment's knock determination device, the engine ECU extracts only the vibrations of the third and fourth order tangential frequency bands from the vibrations detected by the knock sensor. Among the vibrations detected by the knock sensor, the characteristics of the vibrations of the third and fourth order tangential frequency bands are identical to the characteristics of the vibrations of the in-cylinder pressure of the third and fourth order tangential frequency bands. Specifically, among the vibrations detected by the knock sensor, the vibrations of the third and fourth order tangential frequency bands are considered to be specific to knocking. Based on such vibrations, a vibration waveform is detected. Thus, the vibration waveform with less noise other than vibrations attributed to knocking can be obtained. Accordingly, the comparison between the vibration waveform and the knock waveform model can be conducted with high precision. As a result, whether the engine knocks can be determined with high precision.

It is noted that, since the first and second order tangential frequency bands are less than 14 kHz and the third and fourth order tangential frequency bands are at least 14 kHz, a high pass filter 414 may be provided in place of the bandpass filter, as shown in FIG. 11. In this case, integrator 420 may be set to calculate the integrated values irrespective of frequency bands and the compositor may be omitted.

Although the present invention has been described and illustrated in detail, it is clearly understood that the same is by way of illustration and example only and is not to be taken by way of limitation, the spirit and scope of the present invention being limited only by the terms of the appended claims.

1. A knock determination device for an internal combustion engine, comprising:
a vibration detector detecting a vibration of the internal combustion engine;
an extractor extracting from the detected vibration a vibration of at least one of a third order tangential resonance mode frequency band and a fourth order tangential resonance mode frequency band in a cylinder of said internal combustion engine; and
a determiner determining whether said internal combustion engine knocks, as based on the extracted vibration.

2. A knock determination device for an internal combustion engine, comprising:
a vibration detector detecting a vibration of the internal combustion engine;
an extractor extracting from the detected vibration a vibration of at least 14 kHz; and
a determiner determining whether said internal combustion engine knocks, as based on the extracted vibration.

3. The knock determination device for an internal combustion engine according to claim 1 [[or 2]], further comprising:
a waveform detector detecting a waveform of a vibration at predetermined crank angle intervals as based on the extracted vibration; and
a storage storing in advance a waveform of a vibration of said internal combustion engine, wherein
said determiner determines whether said internal combustion engine knocks, as based on a result of comparing the detected waveform with the stored waveform.

4. A knock determination device for an internal combustion engine, comprising:
means for detecting a vibration of the internal combustion engine;
extracting means for extracting from the detected vibration a vibration of at least one of a third order tangential resonance mode frequency band and a fourth order tangential resonance mode frequency band in a cylinder of said internal combustion engine; and
determining means for determining whether said internal combustion engine knocks, as based on the extracted vibration.

5. A knock determination device for an internal combustion engine, comprising:
means for detecting a vibration of the internal combustion engine;
extracting means for extracting from the detected vibration a vibration of at least 14 kHz; and
determining means for determining whether said internal combustion engine knocks, as based on the extracted vibration.

6. The knock determination device for an internal combustion engine according to claim 4 [[or 5]], further comprising:
means for detecting a waveform of a vibration at predetermined crank angle intervals as based on the extracted vibration; and
means for storing in advance a waveform of a vibration of said internal combustion engine, wherein
said determining means includes means for determining whether said internal combustion engine knocks, as based on a result of comparing the detected waveform with the stored waveform.

7. The knock determination device for an internal combustion engine according to claim 2, further comprising:
a waveform detector detecting a waveform of a vibration at predetermined crank angle intervals as based on the extracted vibration; and
a storage storing in advance a waveform of a vibration of said internal combustion engine, wherein
said determiner determines whether said internal combustion engine knocks, as based on a result of comparing the detected waveform with the stored waveform.

8. The knock determination device for an internal combustion engine according to claim 5, further comprising:
means for detecting a waveform of a vibration at predetermined crank angle intervals as based on the extracted vibration; and
means for storing in advance a waveform of a vibration of said internal combustion engine, wherein
said determining means includes means for determining whether said internal combustion engine knocks, as based on a result of comparing the detected waveform with the stored waveform.
